(19) United States
(12) Patent Application Publication
(10) Pub. No.: US 2001/0005555 A1
(43) Pub. Date: Jun. 28, 2001

(54) Cooled heat shield

(76) Inventors: Erhard Kreis, Otelfingen (CH); Christof Pfeiffer, Kuessaberg (DE); Ulrich Rathmann, Baden (CH)

Correspondence Address: BURNS DOANE SWECKER & MATHIS L L P, POST OFFICE BOX 1404, ALEXANDRIA, VA, 22313-1404, US

(21) Appl. No.: 09/726,521

(22) Filed: Dec. 1, 2000

(30) Foreign Application Priority Data
Dec. 28, 1999 (DE) 199 63 371.1

(51) Int. Cl. F01D 5/08; F03B 11/00; F04D 29/58

(52) U.S. Cl. 428/596; 415/177

(57) ABSTRACT

In a heat shield (10), in particular for the stator of gas turbines, which heat shield (10) is composed of a plurality of individual segments (10a, b; 20a, b), whose end surfaces (15a, b) respectively abut one another so as to form a gap (12), and which have cooling holes (13a, b) for cooling purposes in the region of the end surfaces (15a, b), through which cooling holes (13a, b) a cooling fluid is blown out into the gap (12), cooling is ensured, even when the gap is closed, by a chamber (11), which is widened relative to the gap (12) and into which the cooling holes (13a, b) open, being arranged in the region of the gap (12).

The present invention refers to the field of thermal machines. It relates to a heat shield, in particular for gas turbines, as described in the preamble to claim 1.

Such a heat shield is, for example, known from the publications U.S. Pat. No. 4,573,866 or EP-A1-0 516 322.

In thermal machines such as gas turbines, there are certain contours (for example the annular, stator-side heat shields which surround the rotor blades of the rotor), which are composed of individual segments whose end surfaces abut one another so as to form gaps. Such segmented contours require cooling of the flanks by blowing out a cooling fluid, as a rule cooling air. For this purpose, special cooling holes are provided (88 in FIG. 2 of EP-A1-0 516 322 or C in FIG. 3 of U.S. Pat. No. 4,573,866), through which the cooling fluid is blown out into the gaps.

Under certain operational conditions, however, the gaps between the segments can become practically closed. The openings of the cooling holes emerging into the gaps are then covered by the side walls of the adjacent segments, which leads to a failure of the cooling in this region.

The object of the invention is, therefore, to create a heat shield which avoids the quoted disadvantages of known heat shields and, in particular, ensures sufficient cooling of the segment edges near the gaps even when the gaps are closed.

The object is achieved by the totality of the features of claim 1. The core of the invention consists in providing, in the region of the outlet flow openings of the cooling holes, a widened space which ensures unhindered emergence of the cooling fluid even when the gap is completely closed.

The invention can be effected in a particularly simple manner if, in accordance with a preferred embodiment, the chamber is configured as a recess, which, starting from the thermally loaded side of the heat shield, extends into the gap. The depth of the chamber is then preferably a specified percentage, in particular between 10% and 90%, of the thickness of the heat shield in the region of the gap.

The length of the chamber is, preferably, a specified percentage of the width of the heat shield, in particular between 10% and 80%.

Further embodiments are evident from the dependent claims.

The invention is explained in more detail below in association with the drawing, using embodiment examples. In the drawing

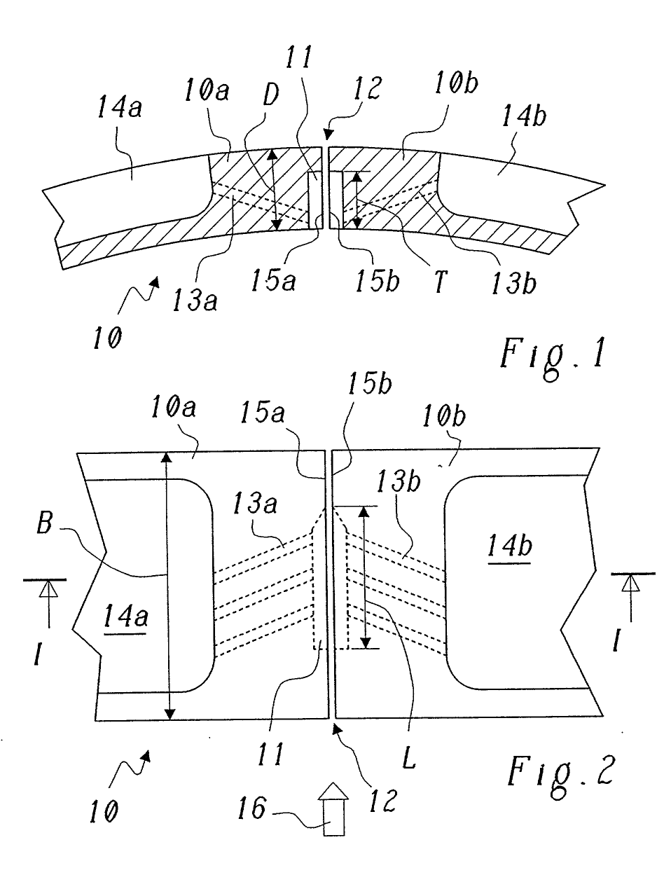

FIG. 1 shows a section, in a plane at right angles to the turbine center line (I-I in FIG. 2), through a heat shield in accordance with a preferred embodiment example of the invention; and

FIG. 2 shows the heat shield of FIG. 1 in plan view from the outside.

FIG. 1 shows a section in a plane, at right angles to the turbine center line, through a heat shield 10 in accordance with a preferred embodiment example of the invention. Of the total annular heat shield 10, two arc-shaped segments 10a and 10b, whose end surfaces 15a and 15b abut one another so as to form a gap 12, are shown as excerpt. The heat shield 10 is subjected from the outside to a cooling fluid, usually cooling air, which also fills the supply spaces 14a and 14b provided on the outside of the segments 10a and 10b. The cooling fluid flows from the supply spaces 14a and 14b, which are configured as recesses, inter alia through corresponding cooling holes 13a and 13b to the gap 12 and is there released into a chamber 11.

The chamber 11, which is, as a recess, let into the gap region from the hot-gas side (from underneath in FIG. 1) has a markedly increased width relative to the gap 12. Should the gap 12 close, this ensures that the cooling fluid can, nevertheless, flow out from the cooling holes 13a and 13b without hindrance and can emerge into the hot-gas space surrounded by the heat shield 10.

The depth T of the recessed chamber 11 depends essentially on the thickness D of the heat shield 10 and should be a certain percentage of D. A percentage of between 10% and 90% has been found expedient, i.e. 0.1 D<T<0.9 D.

The design and position of the chamber 11 of the embodiment example in the axial direction is evident from FIG. 2. The length L of the chamber 11 is likewise a certain percentage of the width B of the heat shield 10, which percentage is preferably between 10% and 80%, i.e. 0.1 B<L<0.8 B.

The cooling holes 13a and 13b expediently extend obliquely inward from the supply spaces 14a, 14b to the chamber 11—as may be seen from FIG. 1. Similarly, as shown in FIG. 2, the cooling holes 13a, b extend obliquely in the direction of the hot-gas flow 16 in order to ensure optimum interaction between the hot-gas flow and the emerging cooling fluid.

It is obvious that within the framework of the invention, the chamber 11 can also be otherwise designed and arranged in the gap region. In the case of a plurality of cooling holes, it is, similarly, conceivable to provide each cooling hole with its own chamber.

List of designations

10, 20 Heat shield

10a, b Segment (heat shield)

11 Chamber (recess)

12, 22 Gap

13a, b Cooling hole

14a, b Supply space

15a, b End surface

16 Hot-gas flow

1. A heat shield (10), in particular for the stator of gas turbines, which heat shield (10) is composed of a plurality of individual segments (10a, b; 20a, b), whose end surfaces (15a, b) respectively abut one another so as to form a gap (12), and which have cooling holes (13a, b) for cooling purposes in the region of the end surfaces (15a, b), through which cooling holes (13a, b) a cooling fluid is blown out into the gap (12), characterized in that a chamber (11), which is widened relative to the gap (12) and into which the cooling holes (13a, b) open, is arranged in the region of the gap (12).

2. The heat shield as claimed in claim 1, characterized in that the chamber (11) is configured as a recess which, starting from the thermally loaded side of the heat shield (10), extends into the gap (12).

3. The heat shield as claimed in claim 2, characterized in that the depth (T) of the chamber (11) is a specified percentage, preferably between 10% and 90%, of the thickness (D) of the heat shield (11) in the region of the gap (12).

4. The heat shield as claimed in one of claims 1 to 3, characterized in that the length (L) of the chamber (11) is a specified percentage of the width (B) of the heat shield (10), preferably between 10% and 80%.

5. The heat shield as claimed in one of claims 1 to 4, characterized in that the cooling holes (13a, b) extend obliquely in the direction of the hot-gas flow.
